(19) United States
(12) Patent Application Publication
(10) Pub. No.: US 2005/0156001 A1
(43) Pub. Date: Jul. 21, 2005

(54) Electronic control system for a bicycle

(75) Inventors: Giuseppe Dal Pra, Zane (Vicenza) (IT); Andrea Berno, Torri di Quartesolo (Vicenza) (IT)

Correspondence Address: VOLPE AND KOENIG, P.C., UNITED PLAZA, SUITE 1600, 30 SOUTH 17TH STREET, PHILADELPHIA, PA, 19103, US

(73) Assignee: Campagnolo S.r.I., Vicenza (IT)

(21) Appl. No.: 11/029,576

(22) Filed: Jan. 5, 2005

(30) Foreign Application Priority Data
Jan. 7, 2004 (EP) 04425004.1

(51) Int. Cl. B62J 11/00; B62K 1/00

(52) U.S. Cl. 224/414; 280/281.1

(57) ABSTRACT

An electronic control system for a bicycle comprising a first containment unit for an electronic device or for a power supply device and a second containment unit for a power supply device or for an electronic device. The two units are mechanically removably connected to each other through snap fastening means provided with an actuation button.

### FIELD OF THE INVENTION

The present invention concerns an electronic control system for a bicycle, and in particular a fastening device between the containment units inside which the electronic devices and the power supply devices making up such a system are housed.

### BACKGROUND

Such a control system is associated, for example, with a powered gearshift device, which allows the assisted gear-shifting of the chain between crowns and sprockets of different diameters.

Such types of system usually provide a containment unit for an electronic control device, such as integrated electronic boards, with which a containment unit for a power supply device, such as for example a battery, is associated.

The known control systems are not completely satisfactory because the mechanic connection is not completely secure in racing conditions when the bicycle is subject to stresses and vibrations, or else following accidental collisions. The fastening can be insufficient and lead to the releasing of the auxiliary containment unit from the containment unit for the electronic board. This may result in breakage or loss of the auxiliary container in a race and the consequent blocking of the functions carried out by the electronic system.

The known control systems are also not completely satisfactory due to the complexity of construction and assembly of the device.

The object of the present invention is to improve upon the known control systems.

### SUMMARY

A first object of the invention is to create an electronic system for a bicycle which is more secure and reliable with respect to devices of a known type.

Another object of the invention is to create an electronic system which allows the operations of assembling the containment units making it up to the frame of the bicycle to be simplified.

Such objects are accomplished through an electronic control system for a bicycle comprising a first containment unit for an electronic device or for a power supply device and a second containment unit for a power supply device or for an electronic device, characterized in that said units are mechanically removably connected to each other through snap fastening means provided with an actuation button.

Advantageously, the two units making up the system of the invention are mechanically connected to each other in a secure manner when they are assembled and can easily be disconnected through the actuation of the button to release the second containment unit from the first containment unit and to allow, for example, the replacement or recharging of the power supply device.

According to a preferred embodiment, the system of the invention constitutes the anchoring part of a support element for bicycle accessories and more specifically for a bottle-cage. In such a case, a retaining part of the accessory part is associated with the anchoring part.

Still according to the preferred embodiment, the first containment unit is shaped with substantially longitudinal layout and is fastened to the bicycle frame whereas the box-like shaped second containment unit extends perpendicularly cantilevered with respect to the first containment unit.

### BRIEF DESCRIPTION OF THE DRAWINGS

Further characteristics and advantages of the invention shall appear from the following description with reference to the attached drawings, provided purely as a non-limiting example, wherein:

FIG. 1 represents, in an isometric view, the electronic system of the invention associated with a bottle-cage;

FIG. 2 represents an exploded isometric view of the system of FIG. 1;

FIG. 3 represents a side view of the system of FIG. 1 with a bottle inserted in the bottle-cage;

FIG. 4 represents a partial section along axis I°-I° of FIG. 1 in a first operating position;

FIG. 5 represents a partial section along axis I°-I° of FIG. 1 in a second operating position;

FIG. 6 represents, in a partial exploded isometric view, a variant embodiment of the invention.

### DETAILED DESCRIPTION OF THE PREFERRED EMBODIMENTS

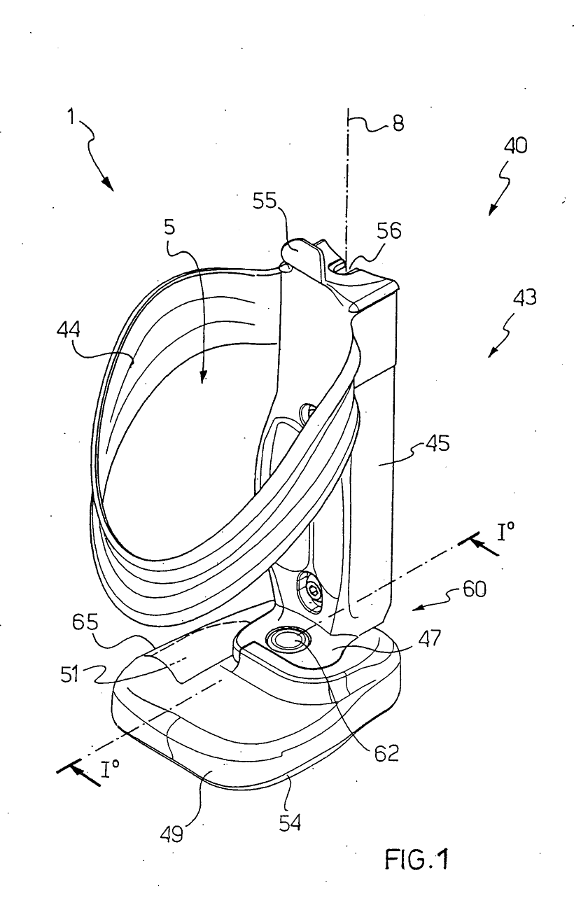

The electronic control system of the invention is represented in FIGS. 1 to 3 where it is globally indicated with 40.

The system of the invention 40 constitutes the anchoring part 43 of a bottle-cage, globally indicated with 1.

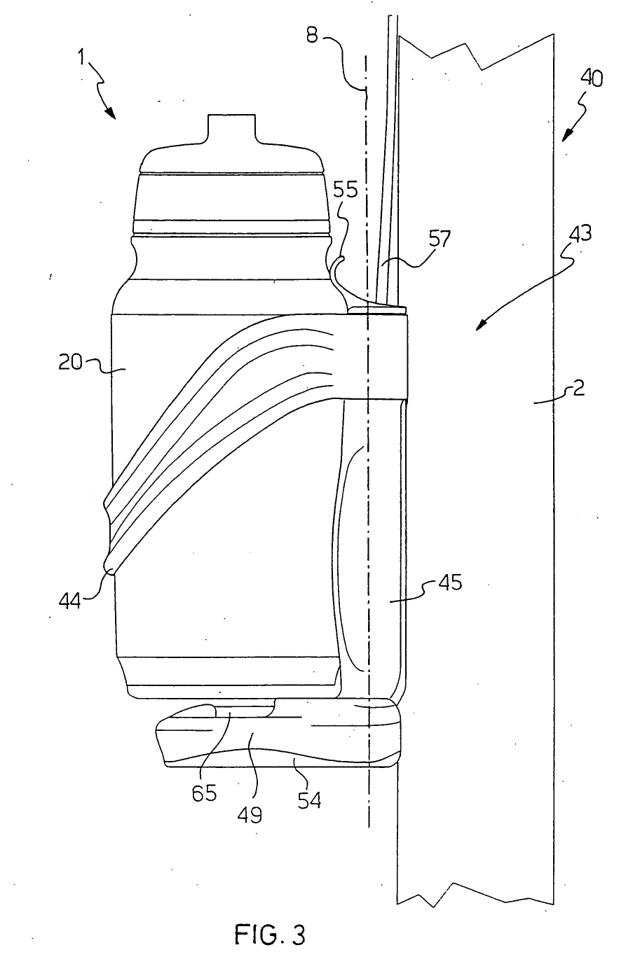

In FIG. 3, the bottle-cage 1 is represented mounted to the frame 2 of a bicycle and essentially consists of an anchoring part 43 for fastening to the frame 2 of the bicycle and a retaining part 44 associated with the anchoring part 43. The retaining part 44 defines a seat 5 with a substantially circular section, matching the body of a bottle 20. Such a section can be chosen according to different configurations should it be foreseen that the accessory to be inserted has a different shape.

The anchoring part 43 and the retaining part 44 are connected to each other through a gluing substance. In different embodiments, instead of the gluing substance equivalent known connection means can be used, like for example rivets or screw coupling means.

The retaining part 44 is preferably made of a structural composite material and in particular of long structural carbon fibers incorporated in a matrix of thermo-setting plastic material, such a composite material being commonly referred to as “carbon fiber”. The anchoring part 43 is made of a plastic material and in particular of a thermoplastic material reinforced with glass grains. The use of such materials allows particular characteristics of structural strength to be granted to the retaining part 44 and to the anchoring part 43 and at the same time allows the weight of the support element 1 to be kept very low. It should be understood, however, that in other embodiments different combinations of materials can be provided for parts 43 and 44. For example both parts 43, 44 can be made of structural composite material, or both of reinforced or non-reinforced plastic material or also the retaining part 44 can be made of plastic material and the anchoring part 43 of composite material.

Furthermore, the long structural fibers of composite material can alternatively be chosen from glass fibers, aramidic fibers, ceramic fibers, boron fibers or any combination thereof. At the same time, the non-structural elements of the reinforced plastic material can be chosen from short carbon fibers, short glass fibers, minerals or any combination thereof.

The aforementioned materials used to make the parts making up the support element of the invention advantageously have specific weights lower than 2.5 Kg/dm³.

The retaining part 43 is comprised of a first containment unit 45 inside which an electronic device and/or a power supply device therefor are arranged, not represented for the sake of simplicity in the figures. Such devices are advantageously mounted on board to the bicycle to carry out particular functions, such as for example the management of a control system for an electronic gearshift or the management of an acquisition and display device of the functions of the bicycle, commonly known as bicycle computer.

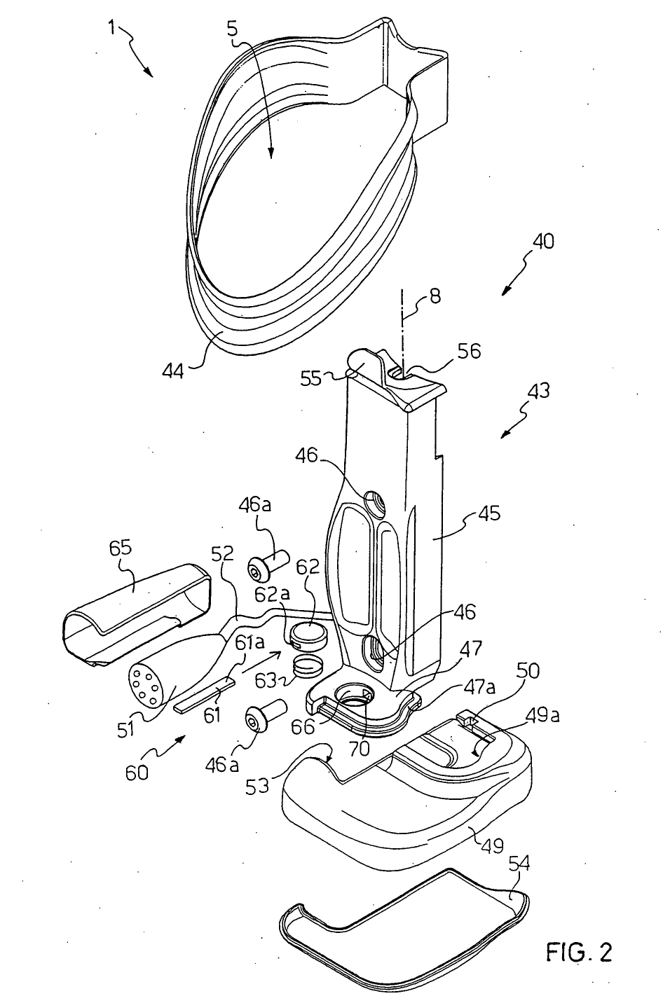

As can be seen more clearly in FIGS. 2 and 3, the first containment unit 45 extends along the main direction 8 of insertion of the bottle 20 and comprises a lower portion 47 which extends perpendicularly with respect to the direction 8 for the support of the bottom of the bottle 20 when it is inserted in the bottle-cage 1.

A box-shaped second containment unit 49, which also extends perpendicularly with respect to the direction 8, for a power supply device for the electronic device, typically a rechargeable battery, is mechanically connected to the lower portion 47. The second containment unit 49 is closed at the bottom by a cover 54.

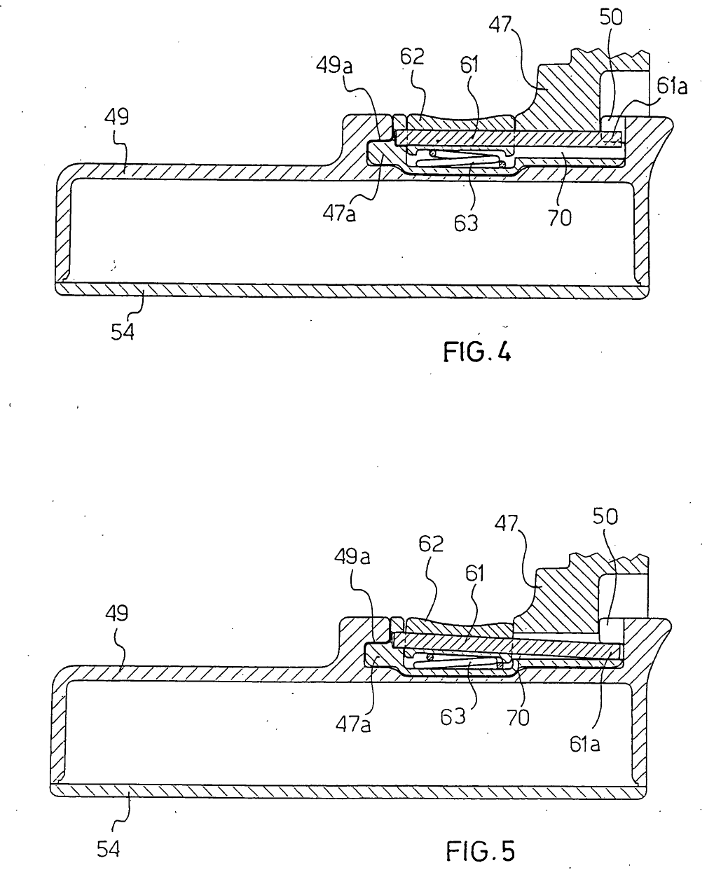

The second containment unit 49 and the lower portion 47 are mechanically removably connected to each other through an undercut edge 49a formed on top of the second containment unit 49, which receives for coupling a shaped edge 47a formed peripherally in the lower portion 47 and having a shape matching the undercut edge 49a. To allow a more secure connection between the second containment unit 49 and the lower portion 47, snap fastening means are provided, globally indicated with 60. Such snap fastening means 60 comprises a pin 61 and a button 62 arranged in a cylindrical seat 66, formed in the lower portion 47, which receives the aforementioned pin 61 in a first through hole 62a. The pin 61 passes through a second through hole 70 formed in the lower portion 47, as can be seen more clearly in FIGS. 4 and 5, and engages with its end 61a in a recessed zone 50 formed in the second containment unit 49. A helical spring 63 is arranged below the button 62 inside the cylindrical seat 66. Such a spring 63 applies a normal force upwards onto the button 62 and the pin 61 inserted in the through hole 70. In different embodiments, instead of the spring 63 any equivalent elastic element of a known type can be used.

When the second containment unit 49 is connected to the lower portion 47, like in the configuration shown in FIG. 4, the end 61a of the pin 61 is kept in abutment inside the recessed zone 50 thanks to the aforementioned upward biasing force of the spring 63 against the button 62 which, in turn, biases the pin 61 upwards. To accomplish the detachment of the second containment unit 49, as can be seen in FIG. 5, the button 62 is biased downwards compressing the spring 63, the pin 61 is in turn biased downwards moving inside the second hole 70. In such a way, the end 61a of the pin 61 comes out from the bottom of the recessed zone 50 allowing the removal of the second containment unit 49 through its sideways translation with respect to the lower portion 47 (with reference to FIG. 3, moving the second containment unit 49 in a direction towards the observer).

It is clear that in variant embodiments, the snap fastening means could be made in a different and equivalent way, for example providing a button associated with the second containment unit 49 which elastically moves a counter acting element that engages in a corresponding recessed zone 50 present in said lower portion 47 or directly in the first containment unit 45.

In this case it is not strictly necessary for the lower portion 47 to extend with respect to the main axis 8. The mechanical connection with the second containment unit 49 could also be obtained, indeed, by forming an undercut edge in the lower portion of the first containment unit 45, which receives for coupling a shaped edge formed in the second containment unit and having a shape matching the undercut edge of the lower portion. It is clear that in such a variant, the support function of the bottle is carried out by the second containment unit 49.

Moreover, the lower portion 47 can extend away from the bicycle frame with respect to the main axis but be smaller in size. In such a case, it can be foreseen that the support function of the bottle be advantageously carried out, as in the previous case, by the second containment unit 49.

The electrical connection between the power supply device arranged inside the second containment unit 49 and the electronic device arranged inside the first containment unit 45, is accomplished through a polar connector 51 which is electrically connected through the cable 52 to the electronic device. The connector 51 is also removably associated with the second containment unit 49 through engagement into a suitable connection socket 53. A removable covering element 65 further allows the protection of the electrical connections from external agents, in particular water.

In the first containment unit 45, and in an upper position, there is an elastically deformable holding tongue 55 which extends towards the seat 5 for receiving the bottle 20. The tongue 55 contributes to improving the holding in position of the bottle 20 by resting against its outer surface, as can be seen in FIG. 3.

The rear side of the first containment unit 45 facing towards the frame is advantageously hermetically closed through a closing element (not shown in FIGS. 1 to 5) which allows the protection of the electronic device from external agents like rain, mud and dust.

The anchoring part 43 is made integral with the frame 2 through screw fastening means consisting of two screws 46a arranged passing through respective through holes 46 formed in the first containment unit 45.

Such screws 46a, engaging in corresponding threaded holes present in the frame 2, not shown in the figures, allow the fastening at two points of the support element 1 to the bicycle. It is clear that the screw fastening means could, in different solutions, be replaced by different but equivalent means, like for example a clamp.

Finally, in the containment unit 45 there is an upper opening 56 which allows the passage of electrical cables 57 towards the outside, as can be seen in FIGS. 1 to 3, and which are connected inside the electronic device.

The positioning of the bottle 20 in the support element 1 takes place substantially through its insertion in the seat 5. During such insertion, the walls of the bottle 20 come into contact with the inner wall of the annular retaining part 44, whereas the bottom of the bottle 20 slides along the second containment unit 45 until it abuts against the lower portion 47. The bottle 20 is kept in the inserted position thanks to the force of the annular part 44 applied on the bottle 20. The deformable tongue 55 then, as stated, improves the holding in position of the bottle 20, resting against its outer surface.

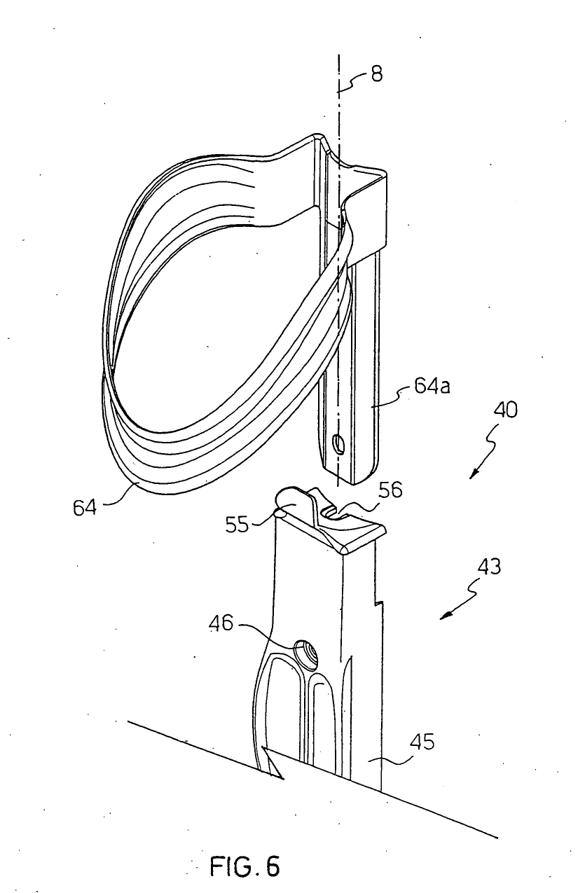

FIG. 6 represents a variant of the system described with reference to FIGS. 1 to 5 and differs therefrom in the configuration of the retaining element 64. Indeed, it has an appendix 64a which protrudes downwards and along the main direction 8 which acts, advantageously, as a hermetic closing element of the first containment unit 45 in its portion facing towards the bicycle frame, with reference to the bottle-cage in mounted configuration.

In another variant, the power supply device could be arranged inside the first containment unit 45 and the electronic device could be arranged inside the second containment unit 49.

1. Electronic control system for a bicycle comprising a first containment unit and a second containment unit, the units being for a respective one of an electronic device and a power supply device, wherein said units are mechanically removably connected to each other through snap fastening means provided with an actuation button.

2. System according to claim 1, wherein said actuation button is associated with said first containment unit and elastically moves a counter acting element which engages in a recessed zone formed in said second unit.

3. System according to claim 1, wherein said actuation button is associated with said second containment unit and elastically moves a counter acting element which engages in a recessed zone formed in said first containment unit.

4. System according to claim 2, wherein said counter acting element consists of a pin passing through a first hole formed in said actuation button, an end of said pin being received in said recessed zone when said second containment unit is connected to said first containment unit.

5. System according to claim 2, wherein said actuation button is received in a seat formed in said first containment unit and elastically cooperates with a spring arranged in said seat.

6. System according to claim 1, wherein said second containment unit has a socket for the connection of a disconnectable electrical connector, in turn connected to an electric cable associated with said first containment unit.

7. System according to claim 1, wherein said first containment unit constitutes the anchoring part of a support element for accessories that can be fastened to a frame of the bicycle.

8. System according to claim 7, wherein said first containment unit extends in a substantially longitudinal direction along a main direction of insertion of said accessories.

9. System according to claim 8, wherein said first containment unit comprises a lower portion shaped for the connection of the second containment unit.

10. System according to claim 9, wherein said lower portion extends away from the bicycle frame.

11. System according to claim 10, wherein said lower portion constitutes the support for the bottom of said accessories, when inserted in said support element.

12. System according to claim 9, wherein said second containment unit extends away from the bicycle frame.

13. System according to claim 12, wherein said second containment unit constitutes the support for the bottom of said accessories, when inserted in said element.

14. System according to claim 9, wherein said second containment unit comprises an undercut edge for coupling with a shaped edge formed in said lower portion and having a shape matching said undercut edge.

15. System according to claim 9, wherein said lower portion comprises an undercut edge for coupling with a shaped edge formed in said second containment unit and having a shape matching said undercut edge.

16. System according to claim 7, wherein said first containment unit has at the top an elastically deformable holding tongue cooperating with said accessories, when inserted in said support element.

17. System according to claim 7, comprising at least one retaining part defining a seat suitable for receiving said accessories.

18. System according to claim 17, wherein said retaining part comprises an appendix extending substantially in a main direction of insertion of said accessories, suitable for defining a closing element for said first containment unit.

19. System according to claim 17, wherein said anchoring part and said retaining part are distinct from each other and connected through joining means, and wherein said anchoring part and said retaining part are both made of a polymeric material.

20. System according to claim 17, wherein at least one of said anchoring and retaining parts comprises a structural composite material comprising structural fibers incorporated in a matrix of a polymeric material.

21. System according to claim 17, wherein at least one of said anchoring and retaining parts comprises a reinforced plastic material comprising non-structural reinforcement elements incorporated in a polymeric material.

22. System according to claim 20, wherein said structural fibers are selected from the group comprising carbon fibers, glass fibers, aramidic fibers, ceramic fibers, boron fibers and any combination thereof.

23. System according to claim 21, wherein said non-structural reinforcement elements are selected from the group comprising carbon fibers, glass fibers, glass beads, minerals and any combination thereof.

24. System according to claim 17, wherein at least one of said anchoring and retaining parts comprises a thermo-setting plastic material.

25. System according to claim 17, wherein at least one of said anchoring and retaining parts comprises a thermoplastic material.

26. System according to claim 17, wherein said retaining part comprises a structural composite material comprising structural fibers incorporated in a matrix of a polymeric material, and said anchoring part comprises a reinforced plastic material comprising non-structural reinforcement elements incorporated in a polymeric material.

27. System according to claim 17, wherein said retaining part is substantially ring-shaped to transversally embrace said accessories.

28. System according to claim 7, comprising screw fastening means for its fastening to the frame of the bicycle.

29. System according to claim 28, wherein said screw fastening means comprises screws arranged in through holes formed in said first containment unit which engage in respective threaded holes formed in said frame.

30. System according to claim 7, comprising clamp means for fastening said first containment unit to said frame.

31. System according to claim 7, wherein said support element is a bottle-cage.

32. A modular electronic bicycle control system having at least one electronic device, the system comprising:
a) a first housing having an electronic control device located therein; and
b) a second housing having a power supply located therein,
wherein the first and second housings are connected with each other by a snap-fit connection provided with a release element, and the electronic control device and power supply are in releasable electrical communication with one another.

33. The electronic control system of claim 32, wherein the releasable electrical communication is via an electrical connector associated with one of the first and second housings.

34. The electronic control system of claim 32, wherein the release element comprises an aperture and a pin passing therethrough and is elastically biased in a first direction.

35. The electronic control system of claim 34, wherein the pin is receivable within a recess of the second housing to secure the first and second housings to each other.

36. The electronic control system of claim 35, wherein the pin is disengagable from said recess by urging the release element in a direction opposite the first direction, and once disengaged, the housings are separable by sliding relative to one another in a release direction.

37. The electronic control system of claim 32, wherein the electrical communication comprises an electrical socket in one of the first and second housings and a mating electrical connector in the other housing.

38. The electronic control system of claim 32, wherein the first housing comprises a portion forming an anchoring portion of an accessory support that is fixable to a bicycle frame and a lower portion substantially perpendicular thereto.

39. The electronic control system of claim 38, wherein the anchoring portion is fixable to the bicycle frame by fasteners and the accessory support further comprises a retainer to secure an accessory.

40. The electronic control system of claim 38, wherein an accessory to be supported is received by an opening of the retainer and rests on the lower portion of the first housing.

41. Electronic control system for a bicycle comprising:
a) a first containment unit; and
b) a second containment unit,
said units being for a respective one of an electronic device and a power supply device, wherein said units are mechanically removably connected to each other through snap fastening means provided with an actuation button received in a seat formed in said first containment unit and that elastically cooperates with a spring arranged in said seat and moves a counter acting element which engages in a recessed zone formed in said second unit.

42. Electronic control system for a bicycle comprising:
a) a first containment unit; and
b) a second containment unit,
said units being for a respective one of an electronic device and a power supply device, said second containment unit having a socket to connect a disconnectable electrical connector, in turn connected to an electric cable associated with said first containment unit, wherein said units are mechanically removably connected to each other through snap fastening means provided with an actuation button associated with said first containment unit and that elastically moves a counter acting element which engages in a recessed zone formed in said second unit.

43. Electronic control system for a bicycle comprising:
a) a first containment unit; and
b) a second containment unit,
said units being for a respective one of an electronic device and a power supply device, wherein said units are mechanically removably connected to each other through snap fastening means provided with an actuation button associated with said first containment unit and that elastically moves a counter acting element which engages in a recessed zone formed in said second unit and wherein said first containment unit constitutes an anchoring portion of an accessory support element that can be fastened to a bicycle frame.

44. Electronic control system for a bicycle comprising:
a) a first containment unit; and
b) a second containment unit,
said units being for a respective one of an electronic device and a power supply device, wherein said units are mechanically removably connected to each other through snap fastening means provided with an actuation button associated with said first containment unit and that elastically moves a counter acting element which engages in a recessed zone formed in said second unit, wherein said first containment unit constitutes an anchoring portion of an accessory support element that can be fastened to a bicycle frame and wherein said accessory support element further comprises at least one retaining part defining a seat suitable for receiving an accessory.

45. Electronic control system for a bicycle comprising:
a) a first containment unit; and
b) a second containment unit,
said units being for a respective one of an electronic device and a power supply device, wherein said units are mechanically removably connected to each other through snap fastening means provided with an actuation button associated with said first containment unit and that elastically moves a counter acting element which engages in a recessed zone formed in said second unit, wherein said first containment unit constitutes an anchoring portion of a bottle cage that can be fastened to a bicycle frame and wherein said bottle cage further comprises at least one retaining part defining a seat suitable for receiving a bottle.

46. An accessory holder for a bicycle, comprising:
a first housing for anchoring to a bicycle,
retaining means for an accessory, said retaining means being coupled to the first housing,
a second housing releasably connected to the first housing through snap-fastening means provided with an actuation button,
the first and second housings being suitable to house a respective one of an electronic device and a power supply device therefor.

47. An accessory holder for a bicycle, comprising:
a first housing for anchoring to a bicycle having an internal path for an electric cable,
retaining means for an accessory, said retaining means being coupled to the first housing,
a second housing releasably connected to the first housing,
the second housing having an electrical socket that, in a connected condition to the first housing, is at the end of said internal path,
the first and second housings being suitable to house a respective one of an electronic device and a power supply device therefor,
the first and second housings having conjugated snap fastening means provided with an actuation button.

48. A combined accessory holder and electronic control system for a bicycle, comprising:
a first housing releasably connectable to a bicycle, and
a second housing releasably connected to the first housing and thereby indirectly only to the bicycle.
